(19) United States
(12) Patent Application Publication
(10) Pub. No.: US 2014/0124144 A1
(43) Pub. Date: May 8, 2014

(54) PLASTIC PRESSURE HAMMER FOR AN OPTICAL FIBER WELDING MACHINE

(71) Applicant: Yangri Zhao, WeiHai (CN)

(72) Inventor: Yangri Zhao, WeiHai (CN)

(73) Assignee: DH INFORTECH (WEIHAI) INC., WeiHai (CN)

(21) Appl. No.: 14/129,144

(22) PCT Filed: Mar. 2, 2012
(86) PCT No.: PCT/CN2012/000264

§ 371 Date: Dec. 24, 2013

(51) Int. Cl. G02B 6/255

(52) U.S. Cl. CPC G02B 6/2553
USPC 156/436

(57) ABSTRACT

This present disclosure discloses a plastic pressure hammer for the optical fiber welding machine. The pressure hammer includes a pedestal with a mounting hole, a spring, a main body and a cap. The upper part of the main body said above is installed inside the mounting hole of the pedestal. The said cap is fixedly installed on the upside of the pedestal. The said spring is installed between the cap and the main body of the pressure hammer. At the bottom of the main body, there is a tablet. The main body of the pressure hammer is lineal contact installed inside the mounting hole of the pedestal. At the rear end of the tablet at the bottom of the main body, there is a fixing component adaptive to the V-shape groove of the optical fiber welding machine. This disclosed embodiment improves the defect of big shaking gap of the main body, thus the fiber bounce caused by it is avoided, and the accurate positioning of the main body is realized. The adjustability of the pressure hammer is enhanced and at the same time the fracture probability of the fiber is reduced, making the work more efficient.

### TECHNICAL FIELD

This application relates to a plastic pressure hammer used in the optical fiber welding machine.

### BACKGROUND ART

The optical welding machine is mainly used for the fiber construction and maintenance of light wave communication. It produces the arc to welding the two fiber ends and at the same time it uses the collimation principle to propel smoothly to realize the coupling of the mode field of the optical fiber. The pressure hammer is a component installed inside the cover of the optical fiber welding machine. When the fiber is to be welded, the cover is closed to make the pressure hammer adaptive to the V-shape groove of the welding machine. Thus the fiber is pressed and accurately positioned. Because the fiber's diameter is only dozens of micron, and particularly after its coating layer is stripped it is very fragile and easily to fracture, there is the failure of the welding leading the fiber needed to be prepared and welded again. So it will cause the low efficiency of the fiber construction. At the present time, the common used pressure hammers in the market have the main body made of ceramics. They are composed of a pedestal with a round hole, a ceramic main body with a flat front structure, a spring, and a cap. The ceramic main body includes a cylindrical component whose one end is installed in the round hole of the pedestal and the other end has a tablet. The pressure hammer used nowadays has defects as below:

1. In the structure of the present pressure hammer, the cross section of the mounting hole in the pedestal is round. During operation, the cylindrical component linking the tablet moves up and down through the elasticity of the spring set at the top of it, thus presses the fiber by its bottom. In this structure, the complete outer surface of the cylindrical component touches the inside surface of the mounting hole of the pedestal. In order to let the cylindrical component move smoothly up and down, the two surfaces are not completely close to each other. So there are enough gaps between them for the cylindrical component to move smoothly up and down. Because of the gaps, the cylindrical component will shake during operation, and this will cause the fiber bounce during butt jointing causing high loss during fiber welding and even the failure of the welding in some case.

2. The front part of the existing pressure hammer's main body is designed as a flat with a raised tablet, which touches the V-shape groove of the welding machine. When the said flat and the V-shape groove of the welding machine contacts, there are no fixing or adjusting parts. So the flat can move in a large scope horizontally easily causing the tablet not perpendicular to the V-shape groove placing the fiber. Consequently the fiber will be driven by the tablet to deviate from the V-shape groove, causing the welding failure because of the big angle during fiber butt jointing.

3. Most current pressure hammers are made of ceramic material. Because ceramic material is hard and heavy relatively, when the fiber is pressed by it, the fiber is easily to break.

### SUMMARY

The purpose of this disclosure is to solve the said existing problems by providing a kind of plastic pressure hammer used in the optical fiber welding machine. The pressure hammer includes a pedestal with a mounting hole, a spring, a main body and a cap. The upper part of the main body said above is installed inside the mounting hole of the pedestal. The said cap is fixedly installed on the upside of the pedestal. The said spring is installed between the cap and the main body of the pressure hammer. At the bottom of the main body, there is a tablet. The main body of the pressure hammer is installed inside the mounting hole of the pedestal by lineal contact. At the rear end of the tablet at the bottom of the main body, there is a fixing component adaptive to the V-shape groove of the optical fiber welding machine. It improves the defect of big shaking gap of the main body, and thus the fiber bounce caused by it is avoided, and the accurate positioning of the main body is realized. The adjustability of the pressure hammer is enhanced and at the same time the fracture probability of the fiber is reduced, making the work more efficient.

The technical solution of this utility is as follows:

A kind of pressure hammer includes a pedestal with a mounting hole, a spring, a main body and a cap. The upper part of the main body said above is installed inside the mounting hole of the pedestal. The said cap is fixedly installed on the upside of the pedestal. The said spring is installed between the cap and the main body of the pressure hammer. At the bottom of the main body, there is a tablet. The main body of the pressure hammer is installed inside the mounting hole of the pedestal by lineal contact.

At the rear end of the tablet at the bottom of the main body, there is a fixing component adaptive to the V-shape groove of the optical fiber welding machine.

Preferably, the mounting hole of the said pressure hammer's pedestal is a hexagonal hole.

Preferably, the fixing component behind the tablet at the bottom of the hammer's main body is a V-shape bulge.

Preferably, the main body of the pressure hammer is made of lightweight material.

Preferably, the main body of the pressure hammer is made of plastic material.

Comparing to the existing technology, this disclosure has the following beneficial effect:

1. In this disclosure, the mounting hole of the pedestal of the pressure hammer is designed as a hexagon. This makes the main body and the mounting hole of the pedestal matched by a circular column and a hexagonal hole, changing the original surface to surface contact to lineal contact. Though the changes, they match more compact. The shaking gap of the main body of the pressure hammer is reduced, thereby the defect caused by the big shaking gap is improved and the fiber bounce caused by the tablet shaking with the main body is avoided.

2. In this disclosure, the simple tablet at the bottom of the pressure hammer's main boy is changed to a tablet combined with a V-shape bulge. The V-shape bulge can match with the V-shape groove of the welding machine, realizing the accurate locating of the pressure hammer easily. It can guarantee the tablet on the pressure hammer's main body to be vertical to the V-shape groove, i.e. guarantee the tablet on the pressure hammer's main body always to be vertical to the fiber. The adjustability of the pressure hammer is improved, and even if it is not installed very precisely, because of the two v-shape groove meshing design, during operation, the pressure hammer can be adjusted to the right position.

3. The main body of the pressure hammer in this disclosure is made of light weight material, such as plastic material. The hardness and self-weight of the pressure hammer made of the plastic material are less than those of the hammer made of ceramic. So when it presses the fiber, it can guarantee the fiber not to be broken, thus reducing the probability of the fiber breaking and enhancing the work efficiency.

### BRIEF DESCRIPTION OF THE DRAWINGS

FIG. 1 is the figure of the stereo structure of the disclosed embodiment;

FIG. 2 is the figure of the cross section of the disclosed embodiment;

FIG. 3 is the figure of the mounting hole of the pressure hammer of the disclosed embodiment;

FIG. 4 is the figure of V-shape bulge of the main body of the pressure hammer of the disclosed embodiment.

### EMBODIMENT

The technology solution of this utility is described though the following relatively better embodiment. But the following embodiment cannot restrict the protection scope of this disclosed embodiment.

### EXAMPLE

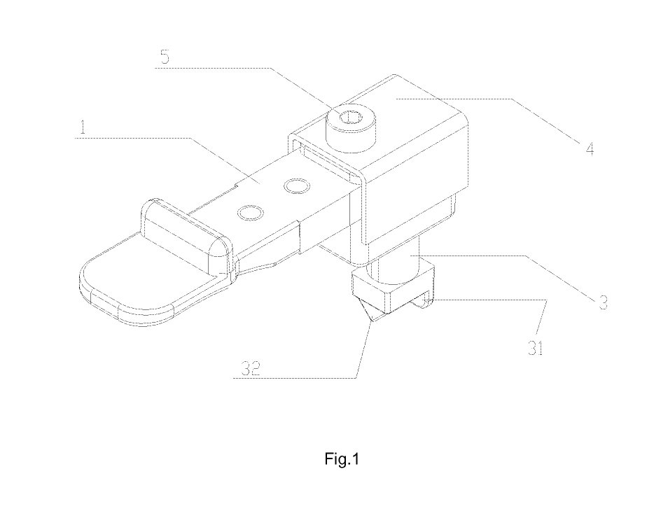

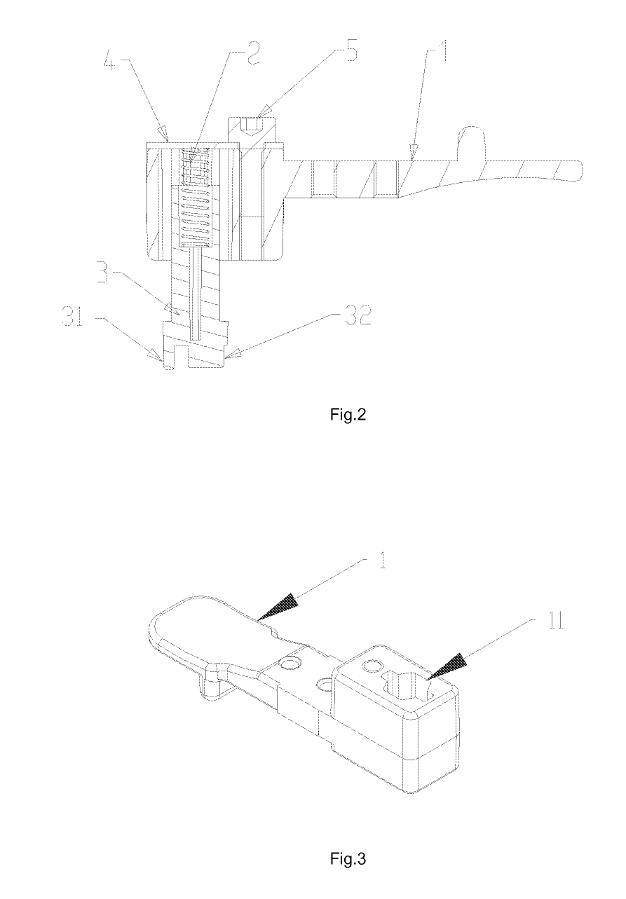

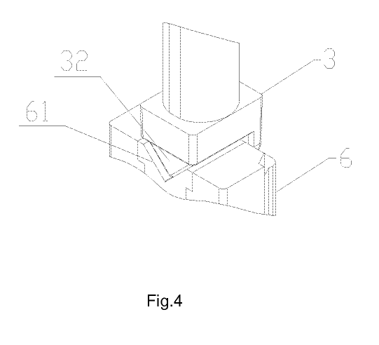

As shown in FIG. 1, FIG. 2, FIG. 3 and FIG. 4, a kind of plastic pressure hammer used in the fiber welding machine includes a pedestal 1 with a hexagon mounting hole 11, a spring 2, a main body 3 and a cap 4. At the two opposite side of the hexagon hole, there are two small through-holes which make installation convenient. The upper part of the main body 3 is installed inside the hexagon mounting hole 11 of the pedestal 1. The round upper part of the main body 3 is installed inside the mounting hole 11 of the pedestal by lineal contact. The said cap 4 is fixedly installed on the upside of the pedestal 1. In this example, the cap 4 is installed at the upside of the pedestal 1 through a pan head screw 5. The spring 2 is installed between the cap 4 and the main body 3 of the pressure hammer. In the example, the main body 3 has a placing hole, and one end of the spring 2 is installed inside the said placing hole, and the other end of it is pressed below the cap 4. At the bottom of the main body 3, there is a tablet 31. At the rear end of the tablet 31, there is a fixing component adaptive to the V-shape groove 61 on the welding machine's core shelf 6. In this example, the said fixing component is a V-shape bulge 32. In practice, the mounting hole can also be of other shapes if it can realize the linear contact with the pressure hammer's main body. And the fixing component of the main body can be trapezoid or other shape bulge if it can match the V-shape groove. Here disclosed is only an example, and this utility doesn't set any limitation on it.

During operation of the plastic pressure hammer of this disclosed embodiment, firstly a screw is used to install the pressure hammer on a pressing arm fixedly connected inside the top cap of the optical fiber welding machine. The top cap and the main body of the welding machine are rotationally connected to each other via a connection shaft, and a core shelf is included in the main body of the fiber welding machine. When the top cap of the welding machine is closed, the plastic pressure hammer moves with it, and the V-shape bulge 32 of the pressure hammer's main body 3 enters the V-shape 61 of the core shelf 6 of the welding machine. After it reaches its accurate position and presses the fiber, the next fiber welding step begins.

In this disclosed embodiment, the main body 3 of the pressure hammer is made of relatively light plastic material. The hardness and self-weight of the pressure hammer made of the plastic material are less than those of the hammer made of ceramic. So when it presses the fiber, it can guarantee the fiber not to be broken easily, thus reducing the probability of the fiber breaking and enhancing the work efficiency.

The embodiment mentioned above is only an example explaining the disclosed embodiment. In addition to the above embodiment, this utility has other embodiments. All embodiments such as equivalent replacements or equivalent changes should fall into the protection scope of this disclosed embodiment.

1. A plastic pressure hammer for an optical fiber welding machine, including a pedestal with a mounting hole, a spring, a main body and a cap, and the upper part of the said main body is installed inside the mounting hole of the pedestal, the said cap is fixedly installed on the upside of the pedestal, and the said spring is installed between the cap and the main body of the pressure hammer, and at the bottom of the main body there is a tablet, characterized in that the main body of the pressure hammer is installed inside the mounting hole of the pedestal by lineal contact, and at the rear end of the tablet at the bottom of the main body of the pressure hammer, there is a fixing component adaptive to the V-shape groove on a core shelf of the optical fiber welding machine.

2. The plastic pressure hammer according to claim 1, characterized in that the mounting hole of the said pressure hammer's pedestal is a hexagonal hole.

3. The plastic pressure hammer according to claim 1, characterized in that the fixing component at the rear end of the tablet at the bottom of the hammer's main body is a V-shape bulge.

4. The plastic pressure hammer according to claim 1, characterized in that the main body of the pressure hammer is made of lightweight material.

5. The plastic pressure hammer according to claim 4, characterized in that the main body of the pressure hammer is made of plastic material.
